(19) United States
(12) Patent Application Publication
(10) Pub. No.: US 2025/0245693 A1
(43) Pub. Date: Jul. 31, 2025

(54) User Interface for Implementing Modifications to a Content Campaign Suggested by a Large Language Model

(71) Applicant: Maplebear Inc., San Francisco, CA (US)

(72) Inventors: Qing Lan, Kenmore, WA (US); Joseph Olivier, San Bruno, CA (US); Rostyslav Myroshnychenko, Milford, PA (US); Peng Qi, Menlo Park, CA (US); Tian Jiang, Toronoto (CA); Michael Becker, Woodbury, NY (US)

(21) Appl. No.: 18/427,725

(22) Filed: Jan. 30, 2024

(51) Int. Cl. G06Q 30/0242

(52) U.S. Cl. CPC G06Q 30/0244

(57) ABSTRACT

An online system publishes sponsored content items to users. To enable a publishing user to evaluate performance of a campaign including sponsored content items and identify modifications to improve the campaign, the online system trains a large language model (LLM). Information about previous campaigns and their performance, previously asked questions about the campaigns, and actions for modifying the campaigns are used to train the LLM. For a particular ad campaign, the online system generates a prompt for the LLM to generate a list of suggestions and corresponding actions. The online system generates an interface including the suggestions in conjunction with interface elements causing performance of one or more of the actions when selected by the publishing user.

### BACKGROUND

Various online systems display different types of content to users. For example, an online system displays organic content items and sponsored content items to users. Organic content items are content items the online system selects for display to a user. One or more organic content items may be selected based on inputs received from a user, such as a search query, with organic content items based on the search query being different search results.

Sponsored content items are content items an online system receives from a publishing user. In exchange for displaying a sponsored content item to a viewing user or in exchange for the viewing user performing a specific action with the sponsored content item, the publishing user may provide some consideration to the online system. For example, a publishing user may be a retailer who provides sponsored content items corresponding to different items offered by the retailer to the online system. Displaying sponsored content items via the online system increases awareness among various viewing users of items identified by the sponsored content items, which increases a likelihood of viewing users purchasing the items or requesting information about the items from the publishing user (or from a retailer).

As the online system presents sponsored content items to viewing users, the online system captures data and generates performance metrics describing effects of the sponsored content items on actions taken by viewing users. For example, the online system captures information identifying a number of times a sponsored content item was displayed to viewing users, a number of discrete viewing users to whom the sponsored content item was displayed, a number of occurrences of a specific action with the sponsored content item by viewing users, or other information describing display of sponsored content items or interactions with sponsored content items. Publishing users review this captured information to evaluate effectiveness of different sponsored content items in causing actions by viewing users. However, many online systems capture a large amount of data describing presentation of various sponsored content items. With online systems capturing large amounts of information describing display of sponsored content items, reviewing the stored information describing display of sponsored content items is time-intensive for publishing users, making evaluating performance of various sponsored content items and subsequent modification to presentation of the sponsored content items impractical for many publishing users.

### SUMMARY

In accordance with one or more aspects of the disclosure, an online system, such as an online concierge system, obtains a campaign including one or more sponsored content items. In some embodiments, the online system receives the campaign from a publishing user. Alternatively, the publishing user identifies a campaign stored by the online system. The online system receives compensation from the publishing user in exchange for displaying a sponsored content item to a viewing user or in exchange for the viewing user performing a specific action after being presented with the sponsored content item. In various embodiments, different sponsored content items are associated with different items offered by a retailer or offered by the online system. For example, each sponsored content item in the campaign is associated with a corresponding item offered by a retailer or by the online system.

Over time, the online system displays various sponsored content items from the campaign to viewing users. For example, the online system includes one or more sponsored content items in interfaces generated and displayed to viewing users in response to requests received from the viewing users. As sponsored content items are displayed to viewing users, the online system captures and stores data describing presentation of different sponsored content to various viewing users. In various embodiments, the stored data includes one or more performance metrics for each sponsored content item of the campaign, and may include one or more performance metrics for the campaign. An example performance metric for a sponsored content item is conversion rate at which users performed a specific action (e.g., selected the sponsored content item, included an item corresponding to the sponsored content item in an order, etc.) after the sponsored content item was presented to the user. Another example performance metric is a cost per impression of the sponsored content item identifying an amount the online system received per presentation of the sponsored content item to other users. Additional or alternative performance metrics may be determined and stored by the online system for various sponsored content items.

The stored data also includes contextual information describing presentation of sponsored content items of the campaign. Examples of contextual information include: questions the online system previously received from the publishing user about the campaign, one or more modifications to the campaign previously performed by the publishing user, other items included in an item catalog associated with the publishing user, other sponsored content items the online system has obtained from the publishing user, or other information describing actions taken by the publishing user or other information associated with the publishing user. In some embodiments, the contextual information includes an indication whether the publishing user made one or more modifications to the campaign after the online system received a question about the campaign from the publishing user. Further, the contextual information includes one or more modifications capable of being made to the campaign, allowing the contextual information to identify actions the publishing user may take to modify presentation of sponsored content items of the campaign.

Analyzing the stored data describing presentation of the sponsored content items of the campaign allows the publishing user to modify or to refine subsequent display of sponsored content items from the campaign based on the stored data. However, the online system may maintain a significant amount of stored data describing presentation of sponsored content items of the campaign. Storing a large amount of data describing sponsored content item presentation provides the publishing user with detailed information about the campaign but increases an amount of time and computational resources for the publishing user to analyze the stored data to determine potential modifications to the campaign. This time and resource consumption may prevent the publishing user from timely performing one or more actions that modify subsequent presentation of sponsored content items from the campaign to increase a likelihood of viewing users performing one or more specific actions after being presented with sponsored content items from the campaign.

To reduce time and resources used for reviewing the stored data describing presentation of sponsored content items of the campaign, the online system generates a prompt for a trained large language model (LLM) based on the sponsored content items of the campaign and the stored data describing presentation of the sponsored content items of the campaign. The prompt includes data describing sponsored content items included in the campaign, at least a subset of stored data describing presentation of sponsored content items included in the campaign, and a set of actions for modifying the campaign. In various embodiments, the prompt includes contextual information from the stored data. Example contextual information included in the prompt includes previously received questions about the campaign, one or more modifications to the campaign by the publishing user, or other actions performed by the publishing user related to display of sponsored content items of the campaign. The prompt also includes a set of actions the publishing user may take to modify the campaign. Based on the received prompt, the LLM generates one or more suggestions for modifying the campaign and one or more actions corresponding to each suggestion. An action corresponding to a suggestion includes instructions that, when executed by the online system, perform a modification to the campaign identified by or described by the suggestion.

In various embodiments, the LLM is a generative model previously trained on a text corpus to output text data comprising one or more suggestions and corresponding actions in response to the received prompt. In various embodiments, the LLM is a generative pre-trained transformer model (GPT). The online system trains the LLM using a training dataset based on stored data describing presentation of additional campaigns, such as campaigns that were previously presented to one or more viewing users. In some embodiments, the training dataset includes stored data associated with additional campaigns describing presentation of sponsored content items in the additional campaigns. For example, the training dataset includes stored data associated with additional campaigns from which the online system displayed sponsored content items during a specific interval. As another example, the training dataset includes stored data associated with additional campaigns having at least a threshold performance metric or having one or more performance metrics satisfying one or more criteria.

In some embodiments, the online system generates the training dataset from stored data describing presentation of additional campaigns having at least a threshold measure of similarity to the campaign. To identify such additional campaigns, the online system generates clusters of other campaigns and obtains the training dataset as stored data associated with additional campaigns in a cluster including the campaign or in a cluster nearest to the campaign. For example, the online system generates an embedding for each campaign and generates clusters of campaigns based on the embeddings. For example, the online system applies a k-means clustering process to embeddings for campaigns to generate clusters of campaigns based on distances between embeddings for different campaigns. The online system obtains the training dataset for the LLM as stored data associated with additional campaigns in a cluster having an embedding for the cluster with a minimum distance, or less than a threshold distance, to an embedding for the campaign. Selecting a cluster of additional campaigns based on characteristics of the campaign allows the online system to obtain training data from additional campaigns most likely to be relevant to the campaign.

In various embodiments, the online system trains the LLM by tuning the LLM using an index generated from the training dataset. Tuning the LLM includes one or more supplemental examples retrieved from the index in the prompt. A supplemental example includes information describing sponsored content items from an additional campaign, data describing presentation of the sponsored content items from the additional campaign, and a set of actions for modifying the additional campaign in conjunction with one or more suggestions and corresponding actions generated based on the data describing presentation of sponsored content items from the additional campaign and the sponsored content items from the additional campaign. To generate the index of supplemental examples, the online system generates an embedding for each supplemental example and stores the embeddings in the index. For example, the embedding for a supplemental example is based on a combination of sponsored content items included in an additional campaign, data describing presentation of the sponsored content items in the additional campaign, a set of actions for modifying the campaign, one or more suggestions generated for the additional campaign, and an action corresponding to each suggestion generated for the additional campaign. In various embodiments, each supplemental example corresponds to a different additional campaign, so the index includes embeddings corresponding to different additional campaigns.

The online system generates an embedding for the campaign based on the stored data describing presentation of sponsored content items of the campaign, the sponsored content items of the campaign, and the set of actions for modifying the campaign. The online system compares the embedding for the campaign to each embedding for a supplemental example stored in the index. Based on measures of similarity between embedding for the campaign and embeddings for supplemental examples, the online system identifies a supplemental example that is similar to the campaign. For example, the online system selects a supplemental example having an embedding with a maximum measure of similarity (e.g., cosine similarity, dot product) to the embedding for the campaign. The online system generates the prompt for the LLM by augmenting data describing the sponsored content items of the campaign, the stored data describing presentation of sponsored content items of the campaign, and the set of actions for modifying the campaign with the selected supplemental example. In some embodiments, the prompt includes the data describing the sponsored content items of the campaign, the stored data describing presentation of sponsored content items of the campaign, the set of actions for modifying the campaign and the embedding of the selected supplemental example. Hence, the LLM is applied to the data describing the sponsored content items of the campaign, the stored data describing presentation of sponsored content items of the campaign, and the set of actions for modifying the campaign combined with the selected supplemental example in various embodiments. This allows the selected supplemental example to provide the LLM with additional context for generating one or more suggestions and corresponding actions for the campaign.

The one or more suggestions generated by the LLM in response to the prompt identify recommendations modifying the campaign. In various embodiments, a suggestion comprises a text description of a modification to the campaign. For example, a suggestion is a suggested question including a modification to the campaign. In other embodiments, the suggestion has one or more alternative formats describing one or more modifications to the campaign.

For each suggestion, the LLM generates a corresponding action. The action comprises instructions that, when executed by the online system modify one or more characteristics of the campaign. For example, a suggestion to remove a sponsored content item from the campaign has a corresponding action comprising instructions that, when executed by the online system, remove the sponsored content item from the campaign. Instructions comprising one or more actions may include an identifier of a sponsored content item affected by the action or one or more values for implementing the action.

To further simplify modifying the campaign based on the LLM output, the online system generates display instructions for an interface that displays at least a set of the generated suggestions and corresponding actions to the publishing user. When executed by a user device of the publishing user, the interface displays a suggestion generated by the LLM and an interface element for the action corresponding to the suggestion. The interface element is associated with the instructions comprising the action that, when executed by the online system, perform the action corresponding to the suggestion. For example, the interface displays text corresponding to a suggestion along with an interface element, which corresponds to instructions for performing action that corresponds to the suggestion. An input with the interface by the publishing user selecting the interface element transmits a request to the online system to execute corresponding to the action, allowing the publishing user to implement the action with a single input via the interface.

Including interface elements that cause performance of a corresponding action by the online system when selected by the publishing user in the interface reduces an amount of input from the publishing user to modify the campaign. Leveraging the LLM to generate suggestions and corresponding actions expedites identification of potential modifications to the campaign for the publishing user. Including interface elements for performing one or more of the generated actions in the interface expedites implementing one or more actions to modify the campaign by allowing the publishing user to implement a generated action by selecting a corresponding interface element in the interface. This prevents the publishing user from manually reviewing the stored data describing presentation of sponsored content items from the campaign, identifying actions to modify the campaign, and manually specifying instructions for execution by the online system to perform the manually identified actions.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 is a flowchart of a method for generating suggestions for modifying a campaign of sponsored content items displayed by an online system using a trained large language model.

FIG. 4 is a process flow diagram of a method for generating suggestions for modifying a campaign of sponsored content items displayed by an online system using a trained large language model.

### DETAILED DESCRIPTION

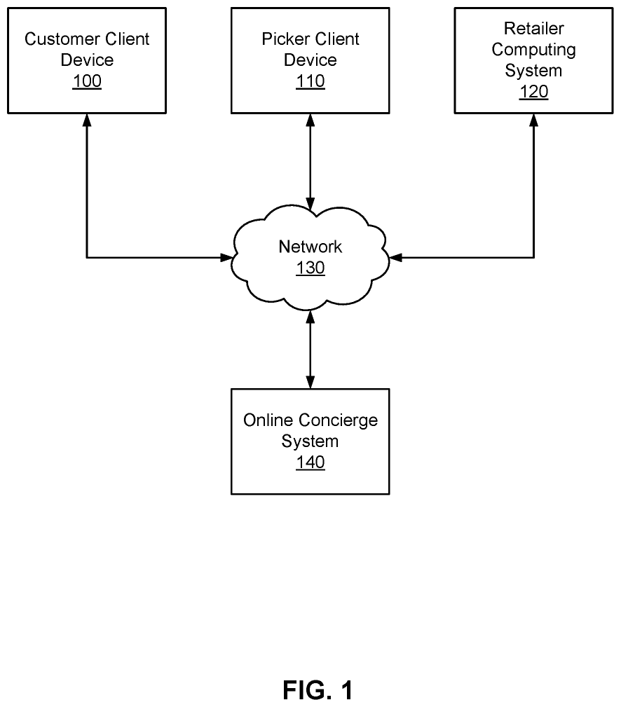

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120. As used herein, a “user client device” generically refers to the customer client device 100, the picker client device 100, or the retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item,” as used herein, means a good or product that can be provided to the customer through the online concierge system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order.

Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The retailer computing system 120 may provide one or more sponsored content items to the online concierge system 140 for display to customers. The retailer provides compensation to the online concierge system 140, or to another online system, in exchange for a customer performing a specific action after being presented with a sponsored content item or in exchange for the online concierge system 140, or other online system, displaying the sponsored content item to customers. In various embodiments, the retailer computing system 120 provides a campaign including multiple sponsored content items to the online concierge system 140, which displays various sponsored content items from the campaign to different customers.

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provides portions of the payment from the customer to the picker and the retailer.

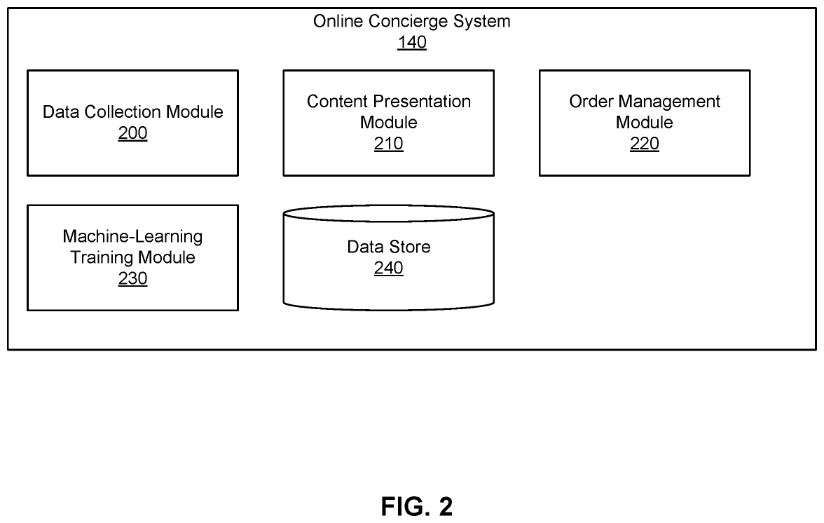

As an example, the online concierge system 140 may allow a customer to order groceries from a grocery store retailer. The customer's order may specify which groceries they want delivered from the grocery store and the quantities of each of the groceries. The customer client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has services orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order.

In various embodiments, the data collection module 200 captures data describing presentation of sponsored content items to various viewing users, such as customers. For example, the data collection module 200 stores an identifier of a viewing user to whom a sponsored content item was presented in association with an identifier of the sponsored content item. The data collection module 200 may also store additional information, such as a description of an interface in which the sponsored content item was presented, a time when the sponsored content item was presented, or other information describing a context in which the sponsored content item was presented. Further, the data collection module 200 may store an indication of whether the viewing user performed a specific action within a threshold time interval after the sponsored content item was presented to the viewing user. The data collection module 200 stores the data describing presentation of the sponsored content item in the data store 240 in association with an identifier of the sponsored content item.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

In various embodiments, the content presentation module 210 includes one or more sponsored content items received from a publishing user in one or more interfaces. For example, the content presentation module 210 includes a combination of one or more sponsored content items and organic content items, which were selected by the content presentation module based on input received from a viewing user and characteristics of the organic content items. The content presentation module 210 may account for characteristics of a viewing user when selecting one or more sponsored content items to present to the viewing user. Different interfaces may include different sponsored content items or include different numbers of sponsored content items.

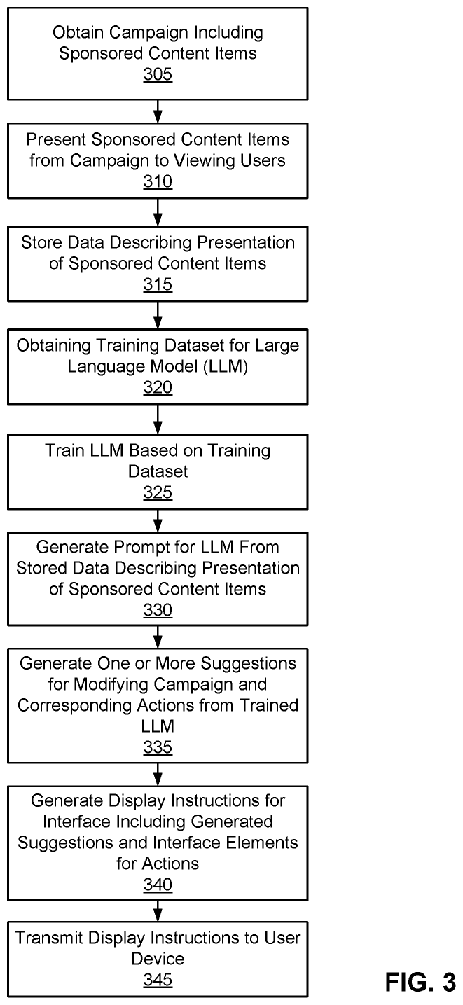

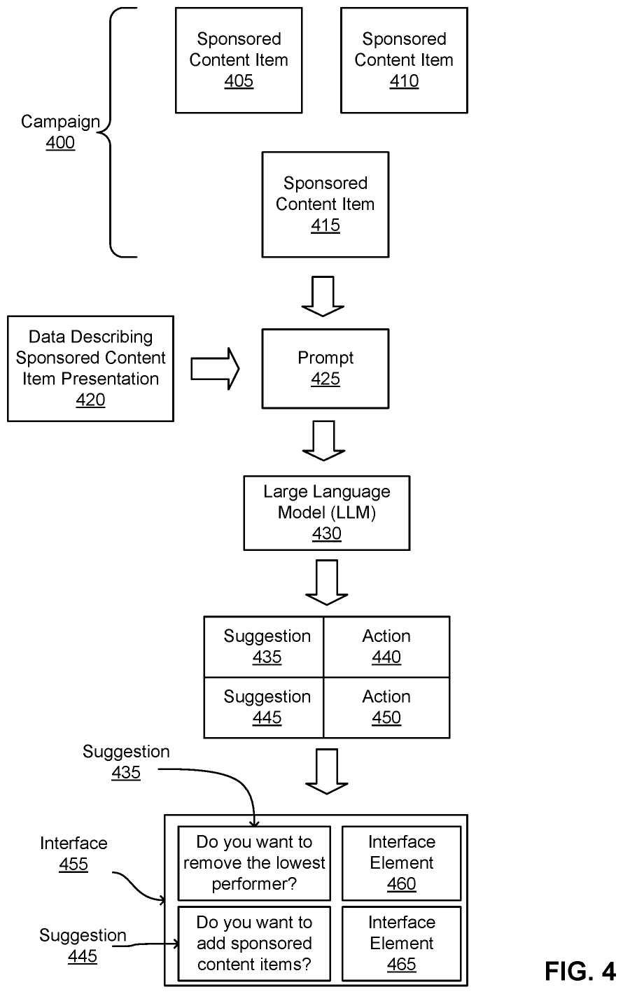

As further described below in conjunction with FIGS. 3 and 4, the content presentation module 210 generates an interface for a publishing user to modify presentation of sponsored content items to viewing users. For example, the online concierge system 140 receives a campaign including one or more sponsored content items from the publishing user and the content presentation model 210 generates an interface identifying potential actions for the publishing user to take to modify subsequent presentation of sponsored content items of the campaign. As further described below in conjunction with FIGS. 3 and 4, the interface includes one or more suggestions for modifying the campaign, with an interface element associated with each suggestion. A suggestion is a textual description of a potential modification to the campaign, and the interface element associated with the suggestion corresponds to instructions that, when executed by the online concierge system 140, cause the online concierge system 140 to perform an action that modifies the campaign to implement the potential modification described by the suggestion. For example, a suggestion indicates removing a sponsored content item with a minimum performance metric from the campaign, and the interface element associated with the suggestion corresponds to instructions that, when executed by the online concierge system, removes the sponsored content item having the minimum performance metric from the campaign. As further described below in conjunction with FIGS. 3 and 4, the content presentation module 210 leverages a trained large language model to generate a set of suggestions displayed by the interface and instructions for performing different suggestions identified by the interface to reduce an amount of time for the publishing user to identify and to implement modifications to the campaign.

The order management module 220 manages orders for items from customers. The order management module 220 receives orders from a customer client device 100 and assigns the orders to pickers for service based on picker data. For example, the order management module 220 assigns an order to a picker based on the picker's location and the location of the retailer location from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine learning training module 230 trains machine learning models used by the online concierge system 140. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 230 updates the set of parameters for the machine learning model based on the score generated by the loss function. For example, the machine learning training module 230 may apply gradient descent to update the set of parameters.

In various embodiments, the machine learning training model 230 trains a large language model (LLM) to receive a text prompt and to output text data. As further described below in conjunction with FIGS. 3 and 4, in various embodiments the LLM receives a prompt comprising sponsored content items of a campaign, data describing presentation of the sponsored content items to viewing users, and a set of actions for modifying the campaign via the prompt and outputs a set of suggestions for modifying the campaign and an action for the online concierge system 140 associated with each suggestion. The LLM is a generative model previously trained on a text corpus to output text data in various embodiments, and the machine learning training module 230 trains the LLM by tuning the LLM based on a training dataset of supplemental examples from stored data describing presentation of additional campaigns, such as campaigns that were previously presented to one or more viewing users.

For example, the online system trains the LLM by tuning the LLM using an index generated from the training dataset. Tuning the LLM includes one or more supplemental examples retrieved from the index in a prompt received by the LLM. A supplemental example includes information describing sponsored content items from an additional campaign and data describing presentation of the sponsored content items from the additional campaign in conjunction with one or more suggestions and corresponding actions generated based on the data describing presentation of sponsored content items from the additional campaign and the sponsored content items from the additional campaign. To generate the index of supplemental examples, the online system generates an embedding for each supplemental example and stores the embeddings in the index. For example, the embedding for a supplemental example is based on a combination of sponsored content items included in an additional campaign, data describing presentation of the sponsored content items in the additional campaign, one or more suggestions generated for the additional campaign, and an action corresponding to each suggestion generated for the additional campaign. In various embodiments, each supplemental example corresponds to a different additional campaign, so the index includes embeddings corresponding to different additional campaigns.

When generating a prompt for the LLM, the online concierge system 140 leverages the index generated by the machine learning training module 230 by identifying a supplemental example from the index in the prompt along with sponsored content items of a campaign, data describing presentation of the sponsored content items to viewing users, and a set of actions for modifying the campaign. To identify the supplemental example included in the prompt, the online concierge system 140 generates an embedding for the campaign based on the stored data describing presentation of sponsored content items of the campaign, the sponsored content items of the campaign, and the set of actions for modifying the campaign. The online concierge system 140 compares the embedding for the campaign to each embedding for a supplemental example stored in the index. Based on measures of similarity between embedding for the campaign and embeddings for supplemental examples, the online concierge system 140 identifies a supplemental example that is similar to the campaign. For example, the online concierge system 140 selects a supplemental example having an embedding with a maximum measure of similarity (e.g., cosine similarity, dot product) to the embedding for the campaign. The online concierge system 140 generates the prompt for the LLM by augmenting data describing the sponsored content items of the campaign, the stored data describing presentation of sponsored content items of the campaign, and the set of actions for modifying the campaign with the selected supplemental example. In some embodiments, the prompt includes the data describing the sponsored content items of the campaign, the stored data describing presentation of sponsored content items of the campaign, the set of actions for modifying the campaign and the embedding of the selected supplemental example.

The data store 240 stores data used by the online concierge system 140. For example, the data store 240 stores customer data, item data, order data, and picker data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

The data store 240 stores sponsored content items received from one or more publishing users (or generated by the online concierge system 140) and data captured by the data collection module 200 describing presentation of sponsored content items. For example, the data store 240 stores a campaign including one or more sponsored content items. As the data collection module 200 captures data describing presentation of sponsored content items of the campaign to viewing users and actions by the viewing users after presentation of the sponsored content items, the data stores 240 stores the captured data in association with a corresponding sponsored content item. For example, the data store 240 stores data describing presentation of a sponsored content item of the campaign in association with an identifier of the sponsored content item, allowing subsequent retrieval of the stored data describing presentation of the sponsored content item.

FIG. 3 is a flowchart for a method for generating suggestions for modifying a campaign of sponsored content items displayed by an online system using a trained large language model, in accordance with some embodiments. Alternative embodiments may include more, fewer, or different steps from those illustrated in FIG. 3, and the steps may be performed in a different order from that illustrated in FIG. 3. These steps may be performed by an online concierge system (e.g., online concierge system 140). Additionally, each of these steps may be performed automatically by the online concierge system without human intervention.

An online system, such as online concierge system 140, obtains 305 a campaign including sponsored content items from various publishing users. In various embodiments, the online system receives the campaign from a publishing user. For example, the publishing user transmits the campaign from a user device or from a third-party system to the online system. Alternatively, the online system receives an identifier of a campaign stored by the online system (e.g., in a data store 240) from the publishing user. The online system may store received sponsored content items in a data store 240 or may retrieve sponsored content items from a third-party system, such as a system associated with a publishing user.

A sponsored content item is a content item for which the online system receives compensation from a publishing user in response to displaying the sponsored content item to one or more viewing users or in response to a viewing user performing a specific action after being presented with the sponsored content item. For example, a publishing user provides compensation to the online system in response to a viewing user selecting the sponsored content item. As another example, a publishing user provides compensation to the online system in response to a viewing user viewing the sponsored content item via the online system.

A campaign includes one or more sponsored content items, with different sponsored content items including information about different items. As another example, a campaign includes multiple sponsored content items related to a specific item, but with different sponsored content items having different formats or including different information about the specific item. Different campaigns may be received 305 at different times or may be received 305 from different publishing users.

The online system stores data describing obtained sponsored content items. For example, the online system stores data describing each sponsored content item included in the obtained campaign. Example data describing a sponsored content item stored by the online system includes an item corresponding to the sponsored content item. For example, the online system stores associations between an identifier of a sponsored content item and an identifier of an item offered by a retailer, or by the online system, corresponding to the sponsored content item. In various embodiments, the online system stores an association between an item and each corresponding sponsored content item in a campaign. Additionally, the online system may identify groups or clusters corresponding to different items that correspond to sponsored content items in a campaign, and store a group or cluster for an item in association with a sponsored content item associated with the item.

The online system presents 310 sponsored content items from the campaign to various viewing users of the online system over time. For example, one or more interfaces generated by the online system and displayed to viewing users include one or more sponsored content items. In an example, an interface includes content items selected by the online system based on a search query received by the online system from a viewing user, with the interface including one or more sponsored content items among the content items. However, the online system may include one or more sponsored content items in other interfaces generated and displayed to viewing users by the online system.

As the online system presents 310 sponsored content items, the online system captures and stores 315 data describing presentation of the sponsored content items. The online system also stores data describing a campaign that is based on data stored 315 in association with sponsored content items of the campaign. For example, the data describing the campaign is based on stored data describing presentation of sponsored content items included in the campaign. In various embodiments, data describing presentation of a sponsored content item is stored in association with an identifier of the sponsored content item. Example data describing presentation of a sponsored content item includes: a number of times the sponsored content item was presented 310 to users, a number of discrete users to whom the sponsored content item was presented 310, times when the sponsored content item was displayed, actions performed by users within a threshold amount of time after the sponsored content item was presented 310 to users, or other data.

In some embodiments, the online system generates one or more performance metrics for a sponsored content item based on presentation of the sponsored content item and actions by users after display of the sponsored content item. For example, a performance metric for a sponsored content item is a conversion rate at which users performed a specific action (e.g., selected the sponsored content item, included an item corresponding to the sponsored content item in an order, etc.) after the sponsored content item was presented to the user. As another example, a performance metric is a cost per impression of the sponsored content item identifying an amount the online system received per presentation of the sponsored content item to other users. However, the online system may determine alternative or additional types of performance metrics in various embodiments. Similarly, the online system stores 315 one or more performance metrics for a campaign based on performance metrics determined for or stored for sponsored content items of the campaign. The online system may store 315 different data in association with different sponsored content items displayed 310 to viewing users.

Additionally, the stored data describing presentation of sponsored content items includes contextual data describing presentation of sponsored content items. Contextual data includes one or more questions or search queries the online system received from a publishing user about a campaign from the publishing user from whom the campaign was obtained. For example, a question the online system receives from a publishing user is a request to identify a sponsored content item from a campaign resulting in a maximum rate of users performing a specific action after being displayed with the sponsored content item. As another example, the online system receives a question from a publishing user to identify a sponsored content item from a campaign resulting in a minimum rate of users performing a specific action after being displayed with the sponsored content item. In other examples, the online system receives a question from a publishing user to identify a sponsored content item in a campaign with a maximum performance metric or receives a question to identify a sponsored content item in the campaign with a minimum performance metric. Other example questions from a publishing user request the online system to identify sponsored content items in a campaign satisfying one or more other criteria specified by the question. The online system stores received questions about a campaign in association with the campaign, allowing the online system to accumulate contextual data describing information the publishing user requested about the campaign from the online system. Further, the contextual information may identify one or more additional sponsored content items associated with the publishing user or additional items associated with the publishing user that are not associated with at least one sponsored content item in the campaign. In some embodiments, the contextual information includes an item catalog identifying items offered by the publishing user.

Contextual data describing presentation of sponsored content items also identifies modifications to the campaign by a publishing user. For example, contextual data stored in association with the campaign indicates whether a publishing user added or removed sponsored content items from the campaign. In another example, contextual data identifies modifications to one or more characteristics of a sponsored content item of the campaign by a publishing user. Example modifications to characteristics of a sponsored content item include: modifying an amount of compensation the publishing user provides the online system for presenting the sponsored content item, modifying an amount of compensation the publishing user provides the online system for viewing users performing a specific action after being presented with the sponsored content item, modifications to content included in the sponsored content item, modifications to targeting criteria that identify characteristics of users to whom the sponsored content item is presented, or modifications to other components or features of the sponsored content item. In various embodiments, contextual data describing presentation of a sponsored content item indicates whether a modification to a characteristic occurred after the online system received a question about the sponsored content item, or about a campaign including the sponsored content item. The contextual data may identify each modification to the campaign by the publishing user, and may identify a time corresponding to each modification.

In some embodiments, contextual data stored 315 in association with the campaign indicates whether a performance metric of the campaign, or of a sponsored content item of the campaign, changed after a modification by the publishing user. For example, contextual data indicates whether a particular performance metric increased or decreased within a threshold amount of time after the modification to the campaign by the publishing user. Alternatively, the contextual data stores an indication that one or more performance metrics changed within a threshold amount of time after a modification to the campaign by the publishing user.

A publishing user from whom the online system obtained 305 the campaign may review data stored 315 by the online system describing presentation of various sponsored content items in a campaign to determine modifications to the campaign affecting subsequent presentation of sponsored content items from the campaign to viewing users. However, the online system may store 315 a large amount of data describing display 310 of sponsored content items in the campaign, increasing an amount of time and computational resources expended by the publishing user to leverage the stored data describing presentation of sponsored content items of the campaign to adjust subsequent presentation of sponsored content items. When review of stored data describing presentation of one or more sponsored content items in a campaign time-intensive and resource-intensive for a publishing user, the publishing user has limited ability to ascertain modifications to the campaign and to implement those modifications to affect subsequent presentation of sponsored content items of the campaign.

To expedite review of stored data describing presentation of sponsored content items in the campaign, the online system leverages a large language model (LLM) to analyze stored data describing presentation of sponsored content items in the campaign. In various embodiments, the LLM is a generative model previously trained on a text corpus to output text data in response to a received prompt. In various embodiments, the LLM is a generative pre-trained transformer model (GPT). The online system obtains 320 a training dataset for the LLM based on stored data describing presentation of various campaigns to viewing users. In some embodiments, the training dataset includes stored data associated with additional campaigns describing display of sponsored content items in the additional campaigns. For example, the training dataset includes stored data associated with additional campaigns from which the online system displayed sponsored content items during a specific interval. As another example, the training dataset includes stored data associated with additional campaigns having at least a threshold performance metric or having one or more performance metrics satisfying one or more criteria.

In other embodiments, the online system generates clusters of other campaigns and obtains the training dataset as stored data associated with additional campaigns in a cluster including the campaign or included in a cluster nearest to the campaign. For example, the online system generates an embedding for each campaign and generates clusters of campaigns based on the embeddings. For example, the online system applies a k-means clustering process to embeddings for campaigns to generate clusters of campaigns based on distances between embeddings for different campaigns. The online system obtains 320 the training dataset for the LLM as stored data associated with additional campaigns in a cluster having an embedding for the cluster with a minimum distance, or less than a threshold distance, to an embedding for the campaign. Selecting a cluster of additional campaigns based on characteristics of the campaign (represented via the embedding of the campaign) allows the online system to obtain 320 training data most likely to be relevant to the campaign.

In some embodiments, the online system trains 325 the LLM by tuning the LLM using an index including various supplemental examples generated from the training dataset. Tuning the LLM includes one or more supplemental examples retrieved from the index in the prompt received by the LLM as input. A supplemental example includes information describing sponsored content items from an additional campaign, data describing presentation of the sponsored content items from the additional campaign, and a set of actions for modifying the additional campaign in conjunction with one or more suggestions and corresponding actions based on the data describing presentation of sponsored content items from the additional campaign and the sponsored content items from the additional campaign. To generate the index of supplemental examples, the online system generates an embedding for each supplemental example and stores the embeddings in the index. For example, the embedding for a supplemental example is based on a combination of sponsored content items included in an additional campaign, data describing presentation of the sponsored content items in the additional campaign, a set of actions for modifying the additional campaign, one or more suggestions generated for the additional campaign, and an action corresponding to each suggestion generated for the additional campaign. In various embodiments, each supplemental example corresponds to a different additional campaign, so the index includes embeddings corresponding to different additional campaigns.

The online system generates an embedding for the campaign based on the stored data describing presentation of sponsored content items of the campaign, the sponsored content items of the campaign, and the set of actions for modifying the campaign. The online system compares the embedding for the campaign to each embedding for a supplemental example stored in the index. Based on measures of similarity between the embedding for the campaign and embeddings for supplemental examples, the online system identifies a supplemental example that is similar to the campaign. For example, the online system selects a supplemental example having an embedding with a maximum measure of similarity (e.g., cosine similarity, dot product) to the embedding for the campaign. The online system generates the prompt for the LLM by augmenting data describing the sponsored content items of the campaign, the stored data describing presentation of sponsored content items of the campaign, and the set of actions for modifying the campaign with the selected supplemental example. In some embodiments, the prompt includes the data describing the sponsored content items of the campaign, the stored data describing presentation of sponsored content items of the campaign, the set of actions for modifying the campaign and the embedding of the selected supplemental example. Hence, the LLM is applied to the data describing the sponsored content items of the campaign, the stored data describing presentation of sponsored content items of the campaign, and the set of actions for modifying the campaign combined with the selected supplemental example in various embodiments. This allows the selected supplemental example to provide the LLM with additional context for generating one or more suggestions and corresponding actions for the campaign.

After training 325 the LLM, the online system generates 330 a prompt for the LLM for the campaign that includes data describing the one or more sponsored content items included in the campaign, at least a subset of the stored data describing presentation of sponsored content items included in the campaign, and a set of actions for modifying the campaign. In various embodiments, the online system generates 330 the prompt in response to receiving a request from the publishing user. The prompt includes the sponsored content items of the campaign, (or information describing each sponsored content item of the campaign), stored data describing presentation of sponsored content items of the campaign, and a set of actions for modifying the campaign. As further described above, the prompt may also include a supplemental example selected from an index. The stored data describing presentation of sponsored content items included in the prompt includes contextual information identifying previously received questions about the campaign, one or more modifications to the campaign by the publishing user, or other actions performed by the publishing user related to display of sponsored content items of the campaign. Based on the received prompt, the LLM generates 335 one or more suggestions for modifying the campaign and one or more actions corresponding to each suggestion. A suggestion is a text description of a modification to the campaign by the publishing user. In some embodiments, a suggestion generated 335 by the LLM is a suggested question for the publishing user. In different embodiments, one or more suggestions generated 335 by the LLM have different formats.

For each generated suggestion, the LLM generates a corresponding action based on the prompt. The action corresponding to a suggestion comprises instructions that, when executed by the online system, perform a modification to the campaign described by the suggestion. The action includes an identifier of one or more sponsored content items of the campaign, values for one or more criteria for selecting a sponsored content item, and instructions to modify one or more characteristics of the campaign in various embodiments. In some embodiments, each suggestion has a corresponding action. Alternatively, each suggestion corresponds to a set of actions. Generating 335 an action corresponding to a suggestion allows the LLM to further simplify the publishing user modifying the campaign by generating instructions for performing a modification to the campaign described by a suggestion.

For example, a suggestion generated 335 by the LLM is removal of a sponsored content item having a minimum performance metric from the campaign, and the LLM generates 335 a corresponding action including instructions for identifying a sponsored content item with the minimum performance metric in the campaign and removing the identified sponsored content item from the campaign. As another example, a suggestion generated 335 by the LLM is inclusion of an additional sponsored content item for an item having at least a threshold measure of similarity to items included in one or more additional campaigns used to train 325 the LLM. The LLM may identify the item based on items included in the item catalog for the publishing user in the contextual data and items associated with sponsored content items in the additional campaigns on which the LLM was trained 325. In conjunction with the suggestion to include the additional sponsored content item, the LLM generates 335 instructions for generating a sponsored content item that include an item identifier for the item having at least the threshold measure of similarity to items included in one or more additional campaigns used to train 325 the LLM.

Based on the one or more suggestions and corresponding actions generated 335 by the LLM, the online system 140 generates 340 display instructions for an interface for display to the publishing user. The interface displays at least a set of the generated suggestions with corresponding interface elements. An interface element corresponding to a suggestion causes the online system to perform the action corresponding to the suggestion when selected by the publishing user. The interface displays a suggestion generated 335 by the LLM and an interface element for executing the action corresponding to the suggestion. In response to a selection of an interface element, the online system receives a request to execute the instructions comprising the action corresponding to the action corresponding to the suggestion associated with the interface element. Hence, selecting an interface element causes the online system to perform a corresponding action that modifies the campaign. For example, the interface displays text describing a suggestion generated 335 by the LLM and a button, link, or other selected interface element proximate to the suggestion that, when selected, causes the online system to perform the action corresponding to the suggestion.

The online system transmits 345 the display instructions for the interface to a user device for the publishing user. The user device executes the display instructions to generate and display the interface to the publishing user. In response to the publishing user selecting an interface element for an action via the interface, the user device transmits a request to the online system to execute instructions corresponding to the interface element. For example, an interface element is displayed proximate to a suggestion to remove a specific sponsored content item from the campaign (e.g., a sponsored content item having a minimum performance metric), and a selection of the interface element by the publishing user via the interface transmits a request to the online system to execute instructions to perform an action corresponding to the suggestion that removes the specific sponsored content item from the campaign. As another example, an interface element is displayed proximate to a suggestion to add an additional sponsored content item corresponding to an additional item to the campaign, so selection of the interface element via the interface transmits a request to the online system to execute instructions that include the additional sponsored content item in the campaign.

Including interface elements causing performance of an action by the online system corresponding to a suggestion when selected by the publishing user simplifies modification of the campaign by the publishing user. The LLM generating suggestions and corresponding actions expedites determination of potential modifications to the campaign. Having interface elements corresponding to different actions that, when selected by the publishing user, cause the online system to perform an action to implement a modification of the campaign, further reduces an amount of time for the publishing user to modify the campaign. Including interface elements corresponding to actions generated by the LLM in the interface allows the publishing user to modify the campaign with a single or with limited interactions with the interface, rather than manually identifying actions and formulating instructions for execution by the online system to perform the manually-identified actions.

In one or more embodiments, instead of transmitting suggestions for modifying a campaign along with the corresponding actions, the system automatically performs the actions associated with one or more of the suggestions. For example, the system may prompt the LLM to provide just an action to improve a particular performance metric for the campaign (i.e., without a suggestion), and then the system may automatically implement that action without requiring input by an entity associated with the campaign. The system may further transmit a message to the user device explaining what change was made, which may optionally include a link for reversing the change that was made to the campaign.

FIG. 4 is a process flow diagram of method for generating suggestions for modifying a campaign of sponsored content items displayed by an online system using a trained large language model, in accordance with some embodiments. As further described above in conjunction with FIG. 3, the online system obtains a campaign 400 including sponsored content item 405, sponsored content item 410, and sponsored content item 415 from a publishing user. The online system receives compensation from the publishing user in exchange for displaying a sponsored content item of the campaign 400 to a viewing user or in exchange for the viewing user performing a specific action after being presented with the sponsored content item of the campaign 400. In various embodiments, different sponsored content items are associated with different items offered by a retailer. For example, sponsored content item 405 is associated with a first item, sponsored content item 410 is associated with a second item, and sponsored content item 415 is associated with a third item.

The online system presents sponsored content item 405, sponsored content item 410, and sponsored content item 415 to various viewing users over time. As sponsored content items are presented to viewing users the online system captures and stores data 420 describing presentation of the different sponsored content items in the campaign 400 to viewing users. The stored data also includes one or more performance metrics for each of sponsored content item 405, sponsored content item 410, and sponsored content item 415. Example performance metrics are further described above in conjunction with FIG. 3. The stored data also identifies contextual information describing presentation of sponsored content items of the campaign 400. Examples of contextual information include: questions the online system previously received about the campaign 400, one or more modifications to the campaign 400 previously performed by the publishing user, other items included in an item catalog associated with the publishing user, other sponsored content items the online system has obtained from the publishing user, or other information describing actions taken by the publishing user or other information associated with the publishing user. Other examples of contextual information are further described above in conjunction with FIG. 3.

Analyzing the stored data 420 describing presentation of the sponsored content items of the campaign 400 allows the publishing user to modify or to refine subsequent presentation of sponsored content items of the campaign 400. This allows the publishing user to refine subsequent performance of the campaign 400 based on the stored data 420. However, the online system may maintain a significant amount of stored data 420 describing presentation of sponsored content items of the campaign. Maintaining a large amount of stored data 420 increases an amount of time and computational resources for the publishing user to analyze the stored data 420 to determine potential modifications to the campaign 400. Having to expend significant time or computational resources to review stored data 420 describing presentation of sponsored content items may prevent the publishing user from determining or implementing modifications to the campaign 400 increasing performance of one or more specific actions by viewing user to whom sponsored content items of the campaign 400 were presented or that increase revenue the publishing user obtains from viewing users to whom sponsored content items of the campaign 400 were presented.

To reduce time and resources spent by the publishing user reviewing the stored data 420 describing presentation of sponsored content items of the campaign 400, the online system generates a prompt 425 for a trained large language model (LLM) 430 based on the sponsored content items of the campaign 400 and the stored data 420 describing presentation of the sponsored content items of the campaign 400, as well as a set of actions for modifying the campaign 400. In various embodiments, the online system generates the prompt 425 in response to receiving a request from the publishing user. The prompt 425 includes data describing the sponsored content items in the campaign 400, at least a subset of stored data 420 describing display of sponsored content items included in the campaign, and the set of actions for modifying the campaign 400. In various embodiments, the subset of stored data 420 describing presentation of sponsored content items of the campaign 400 includes contextual information from the stored data 420. Example contextual information included in the prompt 425 includes previously received questions about the campaign 400, one or more modifications to the campaign 400 by the publishing user, or other actions performed by the publishing user related to display of sponsored content items of the campaign. Based on the received prompt, the LLM 430 generates one or more suggestions for modifying the campaign 400 and one or more actions corresponding to each suggestion. For purposes of illustration, FIG. 4 shows an example where the LLM 430 generates suggestion 435 and action 440 corresponding to suggestion 435, as well as suggestion 445 and action 450 corresponding to suggestion 445.

In various embodiments, the LLM 430 is a generative model previously trained on a text corpus to output text data comprising one or more suggestions and corresponding actions in response to a received prompt, such as prompt 425. In various embodiments, the LLM 430 is a generative pre-trained transformer model (GPT). As further described above in conjunction with FIG. 3, online system trains the LLM 430 using a training dataset including stored data describing display of additional campaigns. In some embodiments, the training dataset includes stored data associated with other campaigns describing display of sponsored content items in the other campaigns. For example, the training dataset includes stored data associated with other campaigns from which the online system displayed sponsored content items during a specific interval. As another example, the training dataset includes stored data associated with other campaigns having at least a threshold performance metric or having one or more performance metrics satisfying one or more criteria.

For example, the online system trains the LLM 430 by tuning the LLM 430 using an index generated from the training dataset. Tuning the LLM 430 includes one or more supplemental examples retrieved from the index in the prompt 425. A supplemental example includes information describing sponsored content items from an additional campaign, data describing presentation of the sponsored content items from the additional campaign, and a set of actions for modifying the additional campaign in conjunction with one or more suggestions and corresponding actions generated based on the data describing presentation of sponsored content items from the additional campaign and the sponsored content items from the additional campaign. To generate the index of supplemental examples, the online system generates an embedding for each supplemental example and stores the embeddings in the index. For example, the embedding for a supplemental example is based on a combination of sponsored content items included in an additional campaign, data describing presentation of the sponsored content items in the additional campaign, the set of actions for modifying the additional campaign, one or more suggestions generated for the prior campaign, and an action corresponding to each suggestion generated for the prior campaign. In various embodiments, each supplemental example corresponds to a different additional campaign, so the index includes embeddings corresponding to different additional campaigns.

With the index generated, the online system generates an embedding for the campaign based on the stored data 420 describing presentation of sponsored content items of the campaign 400 and the sponsored content items of the campaign 400. The online system compares the embedding for the campaign to each embedding for a supplemental example stored in the index. Based on measures of similarity between embedding for the campaign and embeddings for supplemental examples in the index, the online system identifies a supplemental example that is similar to the campaign 400. For example, the online system selects a supplemental example having an embedding with a maximum measure of similarity (e.g., cosine similarity, dot product) to the embedding for the campaign. The online system generates the prompt 425 for the LLM 430 by augmenting data describing the sponsored content items of the campaign 400, the stored data 420 describing presentation of sponsored content items of the campaign 400, and the set of actions for modifying the campaign 400 with the selected supplemental example. In some embodiments, the prompt 425 includes the data describing the sponsored content items of the campaign 400, the stored data 420 describing presentation of sponsored content items of the campaign 400, the set of actions for modifying the campaign 400, and the embedding of the selected supplemental example. Hence, the LLM 430 is applied to the data describing the sponsored content items of the campaign 400, the stored data 420 describing presentation of sponsored content items of the campaign 400, and the set of actions for modifying the campaign 400 combined with the selected supplemental example, This allows the selected supplemental example to provides the LLM 430 with additional context for generating one or more suggestions and corresponding actions for the campaign 400.

The one or more suggestions generated by the LLM 430 in response to the prompt 425 identify modifications to the campaign 400. In various embodiments, a suggestion comprises a text description of a modification to the campaign 400. For example, a suggestion is a suggested question describing modification to the campaign 400. In other embodiments, the suggestion has other formats that describe one or more modifications to the campaign 400.

For each suggestion, the LLM generates a corresponding action. The action comprises instructions that, when executed by the online system modify one or more characteristics of the campaign 400 to implement a modification described by the corresponding suggestion. For example, a suggestion to remove sponsored content item 410 from the campaign 400 has a corresponding action comprising instructions that, when executed by the online system, remove sponsored content item 410 from the campaign. Instructions comprising one or more actions may include an identifier of a sponsored content item affected by the action or one or more values for identifying a sponsored content item affected by the action.

To further simplify modification of the campaign 400 based on the LLM 430 output, the online system generates display instructions for an interface 455 displaying at least a set of the generated suggestions and corresponding actions to the publishing user. When executed by a user device of the publishing user, the interface 455 displays a suggestion generated by the LLM 430 and interface element for performing the action corresponding to the suggestion. The interface element is associated with the instructions comprising the action that, when executed by the online system, perform the action corresponding to the suggestion. In the example of FIG. 4, the interface 455 displays text corresponding to suggestion 435 along with interface element 460, which corresponds to instructions for performing action 440 that corresponds to suggestion 435. Similarly, the interface 455 in the example of FIG. 4 also displays text corresponding to suggestion 445 and interface element 465 that corresponds to instructions for performing action 450 that corresponds to suggestion 445. For example, suggestion 435 is for the publishing user to remove a sponsored content item with a minimum performance metric from the campaign 400, and interface element 460 corresponds to instructions that identify the sponsored content item with the minimum performance metric and remove the sponsored content item with the minimum performance metric from the campaign 400. As another example suggestion 445 is for the publishing user to add an additional sponsored content item to the campaign 400, and interface element 465 corresponds to instructions identifying the additional sponsored content item and modifying the campaign 400 to include the additional sponsored content item. When an interface element is selected by the publishing user via the interface, the online system receives a request from the user device to execute the instructions corresponding to the selected interface element.

Including interface elements that cause performance of a corresponding action by the online system when selected by the publishing user in the interface 455 simplifies modification of the campaign 400 by the publishing user. The LLM 430 generating suggestions and corresponding actions expedites the publishing user identifying potential modifications to the campaign 400. Including interface elements for performing one or more of the generated actions in the interface 455 further reduces time by the publishing user modifying the campaign 400 by allowing the publishing user to implement a generated action by selecting a corresponding interface element in the interface 455. This prevents the publishing user from manually reviewing the stored data 420 describing presentation of sponsored content items from the campaign 400, identifying actions to modify the campaign, and formulating instructions for execution by the online system to perform the manually identified actions.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

1. A method, performed at a computer system comprising a processor and a non-transitory computer readable medium, comprising:
obtaining, at an online system and from a device of a publishing user, a campaign that includes one or more sponsored content items and a set of parameters defining how the one or more sponsored content items are to be published;
publishing, according to the set of parameters, the one or more sponsored content items to a plurality of devices associated with viewing users of the online system, wherein the publishing causes the plurality of devices to display the one or more sponsored content items;
logging data describing interactions by the plurality of devices with the one or more sponsored content items;
tuning a large language model using a dataset of prior campaigns, the dataset of the prior campaigns comprising information about previous presentation of content in previous campaigns, information about modifications made to the previous campaigns, and data indicating a change in a performance metric of a previous campaign after the modifications were made to the previous campaign, wherein the performance metric includes a rate at which the viewing users performed a specific action after the modifications were presented to the viewing users;
generating a prompt for the large language model, the prompt including:
information about the campaign, the information including the set of parameters defining how the one or more sponsored content items are to be published,
at least a portion of the logged data describing interactions by the plurality of devices with the one or more sponsored content items, and
a request that the large language model identify one or more potential modifications to the set of parameters;
providing the prompt to the large language model;
obtaining, from the large language model, one or more potential modifications to the set of parameters;
generating display instructions for an interface displaying one or more of the potential modifications to the set of parameters and a selectable interface element corresponding with each of the one or more potential modifications;
transmitting the display instructions from the online system to the device of the publishing user, wherein the transmitting causes the device of the publishing user to display the interface including the one or more of the potential modifications to the set of parameters and a selectable interface element corresponding with each of the one or more potential modifications;
receiving, from the device of the publishing user, a selection of one of the selectable interface elements;
responsive to receiving the selection of one of the selectable interface elements, modifying the campaign according to the potential modification to the set of parameters associated with the selected selectable interface element; and
publishing, according to the modified set of parameters, the one or more sponsored content items to a subsequent plurality of devices associated with viewing users of the online system, wherein the publishing causes the plurality of devices to display the one or more sponsored content items.

2. The method of claim 1, further comprising:
including, in the generated prompt, a request to provide a text description describing each potential modification to the set of parameters;
receiving, from the large language model, a set of text descriptions describing each potential modification to the set of parameters; and
including, in the generated display instructions, the received text descriptions describing each potential modification to the set of parameters.

3. The method of claim 1, wherein generating the prompt for the large language model comprises:
generating an embedding for the campaign based on the data describing the sponsored content items of the campaign, at least a subset of the logged data describing interactions by the plurality of devices with the one or more sponsored content items, and the set of parameters defining how the one or more sponsored content items are to be published;
determining measures of similarity between the embedding for the campaign and embeddings for supplemental examples corresponding to additional campaigns in an index, each supplemental example including data describing sponsored content items of the additional campaign, data describing presentation of the sponsored content items of the campaign, a set of actions for modifying the additional campaign, and modifications to the additional campaign;
selecting a supplemental example with an embedding having a maximum measure of similarity to the embedding for the campaign; and
including, in the generated prompt, information about the selected supplemental example.

4. The method of claim 1, wherein logging data describing interactions by the plurality of devices with the one or more sponsored content items comprises logging contextual data describing presentation of the sponsored content items of the campaign.

5. The method of claim 4, wherein logging the contextual data comprises logging one or more questions about the campaign the computer system received from the publishing user.

6. The method of claim 4, wherein logging the contextual data comprises logging one or more modifications to the campaign made by the publishing user.

7. The method of claim 4, wherein logging the contextual data comprises logging one or more additional sponsored content items associated with the publishing user.

8. The method of claim 4, wherein logging the contextual data comprises logging an item catalog associated with the publishing user, the item catalog identifying items offered by the publishing user.

9. The method of claim 1, wherein the large language model is trained based on stored data describing one or more additional campaigns including additional sponsored content items presented to viewing users, the additional campaigns each having an embedding within a threshold distance of an embedding for the campaign based on the data describing the sponsored content items of the campaign, at least the logged data describing interactions by the plurality of devices with the one or more sponsored content items, and the potential modifications to the set of parameters.

10. A computer program product comprising a non-transitory computer readable storage medium having instructions encoded thereon that, when executed by a processor, cause the processor to perform steps comprising:
obtaining, at an online system and from a device of a publishing user, a campaign that includes one or more sponsored content items and a set of parameters defining how the one or more sponsored content items are to be published;
publishing, according to the set of parameters, the one or more sponsored content items to a plurality of devices associated with viewing users of the online system, wherein the publishing causes the plurality of devices to display the one or more sponsored content items;
logging data describing interactions by the plurality of devices with the one or more sponsored content items;
tuning a large language model using a dataset of prior campaigns, the dataset of the prior campaigns comprising information about previous presentation of content in previous campaigns, information about modifications made to the previous campaigns, and data indicating a change in a performance metric of a previous campaign after the modifications were made to the previous campaign, wherein the performance metric includes a rate at which the viewing users performed a specific action after the modifications were presented to the viewing users;
generating a prompt for the large language model, the prompt including:
information about the campaign, the information including the set of parameters defining how the one or more sponsored content items are to be published,
at least a portion of the logged data describing interactions by the plurality of devices with the one or more sponsored content items, and
a request that the large language model identify one or more potential modifications to the set of parameters;
providing the prompt to the large language model;
obtaining, from the large language model, one or more potential modifications to the set of parameters;
generating display instructions for an interface displaying one or more of the potential modifications to the set of parameters and a selectable interface element corresponding with each of the one or more potential modifications;
transmitting the display instructions from the online system to the device of the publishing user, wherein the transmitting causes the device of the publishing user to display the interface including the one or more of the potential modifications to the set of parameters and a selectable interface element corresponding with each of the one or more potential modifications;
receiving, from the device of the publishing user, a selection of one of the selectable interface elements;
responsive to receiving the selection of one of the selectable interface elements, modifying the campaign according to the potential modification to the set of parameters associated with the selected selectable interface element; and
publishing, according to the modified set of parameters, the one or more sponsored content items to a subsequent plurality of devices associated with viewing users of the online system, wherein the publishing causes the plurality of devices to display the one or more sponsored content items.

11. The computer program product of claim 10, wherein the non-transitory computer readable storage medium further has instructions encoded thereon that, when executed by the processor, cause the processor to perform additional steps comprising:
including, in the generated prompt, a request to provide a text description describing each potential modification to the set of parameters;
receiving, from the large language model, a set of text descriptions describing each potential modification to the set of parameters; and
including, in the generated display instructions, the received text descriptions describing each potential modification to the set of parameters.

12. The computer program product of claim 10, wherein generating the prompt for the large language model comprises:
generating an embedding for the campaign based on the data describing the sponsored content items of the campaign, at least a subset of the logged data describing interactions by the plurality of devices with the one or more sponsored content items, and the set of parameters defining how the one or more sponsored content items are to be published;
determining measures of similarity between the embedding for the campaign and embeddings for supplemental examples corresponding to additional campaigns in an index, each supplemental example including data describing sponsored content items of the additional campaign, data describing presentation of the sponsored content items of the campaign, a set of actions for modifying the additional campaign, and modifications to the additional campaign;
selecting a supplemental example with an embedding having a maximum measure of similarity to the embedding for the campaign; and
including, in the generated prompt, information about the selected supplemental example.

13. The computer program product of claim 10, wherein logging data describing interactions by the plurality of devices with the one or more sponsored content items comprises logging contextual data describing presentation of the sponsored content items of the campaign.

14. The computer program product of claim 13, wherein logging the contextual data comprises logging one or more questions about the campaign the computer system received from the publishing user.

15. The computer program product of claim 13, wherein logging the contextual data comprises logging one or more modifications to the campaign made by the publishing user.

16. The computer program product of claim 13, wherein logging the contextual data comprises logging one or more additional sponsored content items associated with the publishing user.

17. The computer program product of claim 13, wherein logging the contextual data comprises logging an item catalog associated with the publishing user, the item catalog identifying items offered by the publishing user.

18. The computer program product of claim 10, wherein the large language model is trained based on stored data describing one or more additional campaigns including additional sponsored content items presented to viewing users, the additional campaigns each having an embedding within a threshold distance of an embedding for the campaign based on the data describing the sponsored content items of the campaign, at least the logged data describing interactions by the plurality of devices with the one or more sponsored content items, and the potential modifications to the set of parameters.

19. A system comprising:
a processor; and
a non-transitory computer readable storage medium having instructions encoded thereon that, when executed by the processor, cause the processor to perform steps including:
obtaining, at an online system and from a device of a publishing user, a campaign that includes one or more sponsored content items and a set of parameters defining how the one or more sponsored content items are to be published;
publishing, according to the set of parameters, the one or more sponsored content items to a plurality of devices associated with viewing users of the online system, wherein the publishing causes the plurality of devices to display the one or more sponsored content items;
logging data describing interactions by the plurality of devices with the one or more sponsored content items;
tuning a large language model using a dataset of prior campaigns, the dataset of the prior campaigns comprising information about previous presentation of content in previous campaigns, information about modifications made to the previous campaigns, and data indicating a change in a performance metric of a previous campaign after the modifications were made to the previous campaign, wherein the performance metric includes a rate at which the viewing users performed a specific action after the modifications were presented to the viewing users;
generating a prompt for the large language model, the prompt including:
information about the campaign, the information including the set of parameters defining how the one or more sponsored content items are to be published,
at least a portion of the logged data describing interactions by the plurality of devices with the one or more sponsored content items, and
a request that the large language model identify one or more potential modifications to the set of parameters;
providing the prompt to the large language model;
obtaining, from the large language model, one or more potential modifications to the set of parameters;
generating display instructions for an interface displaying one or more of the potential modifications to the set of parameters and a selectable interface element corresponding with each of the one or more potential modifications;
transmitting the display instructions from the online system to the device of the publishing user, wherein the transmitting causes the device of the publishing user to display the interface including the one or more of the potential modifications to the set of parameters and a selectable interface element corresponding with each of the one or more potential modifications;
receiving, from the device of the publishing user, a selection of one of the selectable interface elements;
responsive to receiving the selection of one of the selectable interface elements, modifying the campaign according to the potential modification to the set of parameters associated with the selected selectable interface element; and
publishing, according to the modified set of parameters, the one or more sponsored content items to a subsequent plurality of devices associated with viewing users of the online system, wherein the publishing causes the plurality of devices to display the one or more sponsored content items.

20. The system of claim 19, wherein the non-transitory computer readable storage medium further has instructions encoded thereon that, when executed by the processor, cause the processor to perform additional steps comprising:
including, in the generated prompt, a request to provide a text description describing each potential modification to the set of parameters;
receiving, from the large language model, a set of text descriptions describing each potential modification to the set of parameters; and
including, in the generated display instructions, the received text descriptions describing each potential modification to the set of parameters.
